(19) United States
(12) Patent Application Publication
(10) Pub. No.: US 2019/0346334 A1
(43) Pub. Date: Nov. 14, 2019

(54) PIPELINE PIG FOR GENERATION OF ACOUSTIC WAVEFORMS

(71) Applicant: Rhediant, Inc., Houston, TX (US)

(72) Inventors: Murat Ocalan, Houston, TX (US); Hossam Elbadawy, Katy, TX (US)

(21) Appl. No.: 15/976,002

(22) Filed: May 10, 2018

(51) Int. Cl. G01M 3/24

(52) U.S. Cl. CPC G01M 3/246

(57) ABSTRACT

A pipeline leak detection system includes a pig movable through a pipeline. The pig comprises an acoustic transducer. A plurality of acoustic sensors is disposed at spaced apart locations along the pipeline. Each acoustic sensor is in signal communication with a central processor. The central processor accepts as input signals detected by each of the plurality of acoustic sensors and compares the detected signals to expected signals to determine performance degradation of the pipeline leak detection system and/or a leak in the pipeline.

### CROSS REFERENCE TO RELATED APPLICATIONS

Priority is claimed from U.S. Provisional Application No. 62/503,933 filed on May 10, 2017 and incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of pipeline systems used to convey fluids, i.e., liquids, gases and mixtures thereof.

Liquid pipelines are utilized to transport, for example, various hydrocarbons and other industrial chemicals. Loss of integrity of a liquid pipeline is a significant industrial accident which can have catastrophic consequences. Large integrity loss events such as pipeline ruptures can be detected by an internal leak detection system using mass balance principles. However, smaller leaks are challenging to detect using internal leak detection systems. To address this issue, operators of hazardous liquid pipelines typically install sensor systems external to the pipeline to successfully detect any small leaks. Even with a large leak, however, pinpointing the precise location of such leaks is challenging. Leak location determination can be accelerated by using an external sensor leak detection system.

Acoustic leak detection systems are relatively new and comprise a growing set of commercial applications. Acoustic leak detection systems rely on acoustic measurements to detect the sound waves propagating from an active leak. Acoustic leak detection can be performed by the use of fiber optics and point sensors installed on or near the pipeline.

It is particularly challenging to validate the effectiveness of deployment of acoustic leak detection systems for sufficient sensitivity to sometimes small leaks. It is also a challenge to validate that the system's sensitivity during the continued operation of the system in a pipeline.

### SUMMARY

A pipeline leak detection system according to one aspect of the disclosure includes a pig movable through a pipeline. The pig comprises an acoustic transducer. A plurality of acoustic sensors is disposed at spaced apart locations along the pipeline. Each acoustic sensor is in signal communication with a central processor. The central processor accepts as input signals detected by each of the plurality of acoustic sensors and compares the detected signals to expected signals to determine performance degradation of the pipeline leak detection system and/or a leak in the pipeline.

In some embodiments, the acoustic transducer comprises a magnetostrictive transducer.

In some embodiments, the pig comprises circuitry to drive the acoustic transducer to generate acoustic waves having a predetermined waveform.

A method for evaluating performance of a pipeline leak detection system according to another aspect includes emitting acoustic energy into the pipeline at a plurality of locations along the pipeline. Acoustic energy is detected at spaced apart locations along the pipeline. Characteristics of the detected acoustic energy to expected characteristics of acoustic energy at the spaced apart locations are compared and at least one of a performance degradation and presence of a pipeline leak is determined using results from the comparing.

In some embodiments, the expected characteristics are determined by detecting the acoustic energy at the spaced apart locations on a pipeline having known leak and acoustic sensor performance characteristics.

In some embodiments, the determining comprises determining existence in the detected acoustic energy at one or more frequencies corresponding to existence of a leak in the pipeline.

In some embodiments, the determining comprises detecting changes in frequency content in the detected acoustic energy corresponding to changes in pipeline wall thickness as a result of damage to or corrosion of the pipeline.

In some embodiments, the determining comprises detecting changes in detected acoustic energy amplitude above a predetermined threshold at any one or more of the spaced apart locations.

In some embodiments, the changes in detected acoustic energy amplitude correspond to one or more selected frequencies.

Other aspects and possible advantages will be apparent from the description and claims following.

### BRIEF DESCRIPTION OF THE DRAWINGS

FIG. 1 shows an example embodiment of a pipeline used to transport a fluid.

FIGS. 2A and 2B show an example embodiment of an acoustic transmitter “pig.”

FIG. 3 shows an example embodiment of an acoustic transmitter.

### DETAILED DESCRIPTION

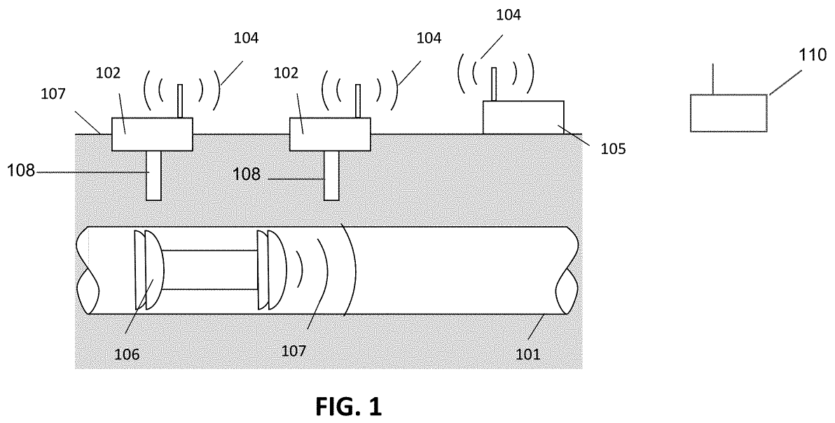

Referring to FIG. 1, a pipeline 101 is shown which may be utilized to transport fluid. A typical pipeline deployed on land may be buried below the ground surface 107 to protect the pipeline 101 from external damage and deterioration; however, this is not essential for the operation of a pipeline system according to the present disclosure. Some onshore pipelines are located above ground 107. Whereas typical offshore pipelines are operated on the seabed.

For various operational reasons a pipeline “pig” may be utilized in the pipeline from time to time, including cleaning of the pipeline, separation of different types of fluids and inspection of the structural condition of the pipeline. A pig is typically deployed in the pipeline and conveyed from one point in the pipeline to another point in the pipeline by the flow of fluid in the pipeline. An embodiment of a pig according to the present disclosure comprises an acoustic transmitter pig 106. The acoustic transmitter pig 106 may utilized in the pipeline 101 to generate acoustic waves 107 that propagate in, on and around the pipeline 101 either while cleaning the pipeline 101, inspecting the pipeline 101 or separating different fluids in the pipeline 101. The acoustic transmitter pig 106 may also be used solely for purposes described herein.

Also deployed on the pipeline 101 is an acoustic leak detection system that may include wireless nodes 102 and gateways 105. The wireless nodes 102 may each contain one or more acoustic sensors that monitor the health of the pipeline 101 by sensing if a leak is present. One or more acoustic sensors 108 in signal communication with or on each of the wireless nodes 102 may be attached to the pipeline 101 or placed in proximity to it at spaced apart locations. The wireless nodes 102 are in wireless communication 104 with one or more gateways 105. The gateways 105 are also in wireless or wired communication with a central server or processor 110. The central server or processor 110 may be implemented in any form usable for analysis of detected signals as explained further below, for example and without limitation, a programmed general purpose computer, a microprocessor, a field programmable gate array, and an application specific integrated circuit.

The data and commands conveyed by a wireless node 102 may be relayed to the central server 110 by the gateway 105. Likewise, data and commands sent by the central server 110 which are addressed to a particular wireless node 102 may be conveyed to that node using the wireless communication channel 104. It is to be clearly understood that wireless nodes and wireless gateways are convenient for purposes of deployment of and communication between acoustic sensors 108 and the central server or central processor 110, but such embodiments do not limit the scope of the present disclosure. Wired or other “hard connected” sensors and central processing systems are within the scope of the present disclosure.

Evaluating performance of the acoustic leak detection system may be performed by inducing acoustic waves having known characteristics in the pipeline 101 and measuring the response from each acoustic sensor 108, such as by interrogating each wireless node 102. Acoustic signals detected by each acoustic sensor may be compared to expected acoustic signals in a device such as the central processor 110; differences between the detected signals and the expected acoustic signals may be related to performance degradation of the leak detection system, or to an actual leak in the pipeline 101.

The acoustic transmitter pig 106 may utilized in an embodiment according to the present disclosure to generate such acoustic waves in the pipeline 101. The acoustic transmitter pig 106 generates acoustic waves 107 having known characteristics, which propagate in the fluid in the pipeline 101, the pipeline walls and the surrounding medium (soil, water and/or air). The propagated acoustic waves in turn may be detected by the acoustic sensor 108 in each wireless node 102.

The detected acoustic waves may be captured in and digitized by suitable circuitry in each wireless node (102 in FIG. 1). The detected, digitized signals, and/or other measured quantities obtainable from the detected acoustic waves, e.g., signal amplitude and Fourier transform (frequency spectrum) may be transmitted to the wireless gateway 105, which then relays this information to the central server or processor 110, where the detected signals may be further analyzed and compared with expected acoustic waveform characteristics. If a sufficiently large discrepancy is observed in this analysis, a failure of or degradation of system performance proximate one or more of the acoustic sensors 108 may be determined and corrective action can be initiated.

In some embodiments, the expected acoustic waveform characteristics may be obtained by operating the acoustic transducer pig 106 and detecting signals at each of the acoustic sensors 108 at a time shortly after the pipeline 101 is placed in service or before the pipeline 101 is placed in service. Such detected signals may be used as a baseline or reference set of measurements presumed to represent acoustic waveform characteristics corresponding to a leak-free pipeline having a properly functioning leak detection system. In some embodiments, the expected acoustic waveform characteristics may be estimated by modeling acoustic response of the pipeline 101, the acoustic sensors 108 and the media surrounding the pipeline 101 to modeled acoustic waves emitted in the pipeline along its length and having predetermined waveform characteristics. In some embodiments, determining a sufficiently large discrepancy may comprise detecting changes in detected signal amplitude above a predetermined threshold at any one or more of the acoustic sensors 108, and in some embodiments at one or more selected frequencies. In some embodiments, determining a sufficiently large discrepancy may comprise detecting energy in the detected signals at one or more frequencies corresponding to existence of a leak in the pipeline. In some embodiments, determining a sufficiently large discrepancy may comprise detecting changes in frequency content in the detected signals corresponding to changes in pipeline wall thickness as a result of damage to or corrosion of the pipeline 101. In some embodiments, the acoustic transducer pig 106 may be tested before deployment in the pipeline 101 to ensure that the acoustic waves 107 have the predetermined waveform characteristics.

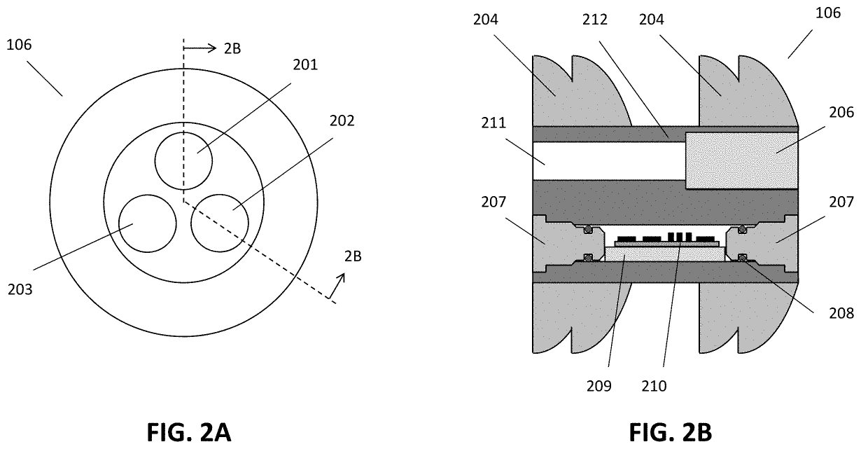

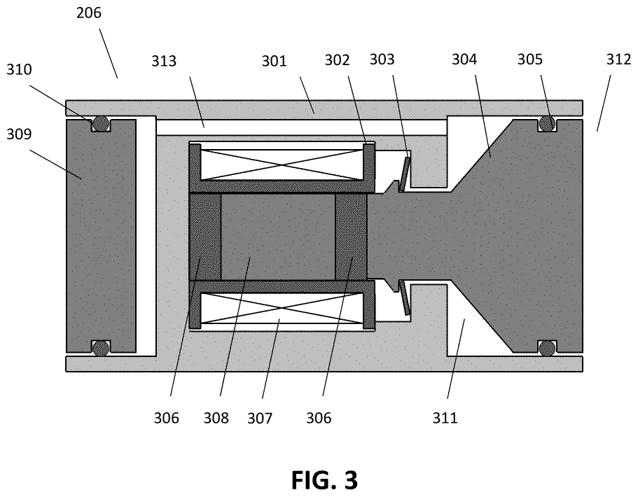

Referring to FIGS. 2A and 2B, the acoustic transmitter pig 106 has one or more cups 204 (FIG. 2B) that fit closely with the inner diameter of the pipeline (101 in FIG. 1). A pig body 212 may have three chambers: a transducer chamber 201 (FIG. 2A), an electronics chamber 202 (FIG. 2A), and a battery chamber 203 (FIG. 2A). The transducer chamber 201 may comprise an acoustic transducer 206 and a vent port 211. The vent port 211 places a compensating piston (309 in FIG. 3) of the acoustic transducer 206 in pressure communication with the pipeline fluid. The electronics chamber 202 may sealed by two plugs 207 and contains an electronics chassis 209 and an electrical circuit board 210, which contains electronics for driving the transducer 206 and for performing auxiliary functions such as providing wired interface during setup and shutdown. The electrical circuit board 210 may comprise (none shown separately) a microcontroller, memory and power electronics amplifiers required to generate sufficient power to drive the transducer 206. Such electronics on the circuit board may enable driving the transducer 206 with any selected or predetermined acoustic waveform. In one embodiment, the acoustic wave may be a 500 Hz sinusoidal wave. The construction of the battery chamber 203 may be similar to that of the electronics chamber 202. The battery chamber may be sealed with a plug 207 on each end. The battery chamber 203 may contain a lithium thionyl chloride primary battery pack that powers the acoustic transmitter pig 106 for the duration of its operation from launch to catch.

Referring to FIG. 3, the acoustic transducer 206 may comprise a magnetostrictive cylinder 308 arranged to drive a front mass 304 which in turn generates acoustic waves (107 in FIG. 1) that propagate into the pipeline fluid 312 it is in contact with. A chamber 311 inside of the transducer 206 may be completely sealed from the pipeline fluids by a front mass seal 305 and a compensating piston seal 310. This chamber 311 may be filled with a substantially incompressible fluid such as silicone oil. This allows the acoustic transducer 206 to operate in a wide range of pipeline internal pressures without inducing a significant load on the magnetostrictive cylinder 308.

With variation in pipeline temperature, the volume of the incompressible fluid, e.g., silicone oil, changes and such change is accommodated by the compensating piston 309. When the temperature increases, the volume of the incompressible fluid increases and the compensating piston 309 moves outwardly to equalize the pressure between the chamber 311 and the pressure in the vent port 211. Sufficient fluid flow path is provided by communication holes 313 for fluid pressure to equalize within the transducer 206 quickly enough to avoid generating differential fluid pressure across the equalizing piston 309.

The magnetostrictive cylinder 308 may be actuated by passing electric current through a wire coil 307 which may be constructed by winding magnet wire on a bobbin 302. When a magnetic field is induced by electric current passing through the coil 307, the magnetostrictive cylinder 308 expands, pushing the front mass 304 out.

It may be advantageous to apply a biasing magnetic field on the magnetostrictive cylinder 308, which may be established by permanent magnets 306. It may also be beneficial to induce a pre-stress on the magnetostrictive cylinder 308 to maximize its performance. This may be established by a Belleville spring 303 which is compressed when the acoustic transducer 206 is assembled, thus inducing this pre-stress.

In other embodiments, the front mass seal 305 and/or the compensating piston seal 310 may be established with the use of diaphragms spanning the front mass 304 and the actuator body 301, and compensating piston 309 and actuator body 309, respectively. The diaphragms can be made from rubber, aluminum or steel materials.

In other embodiments, the front mass seal 305 and/or the compensating piston seal 310 are established with the use of bellows spanning the front mass 304 and the actuator body 301, and compensating piston 309 and actuator body 309, respectively. The diaphragms can be made from rubber, aluminum or steel materials.

In another embodiment, the acoustic transmitter pig 206 may be used for tracking the location of the pig 206 along the pipeline (101 in FIG. 1) and/or a combination of such pigs linked in series. By monitoring the acoustic waves in proximity with the pipeline, it is possible to determine the approximate location of the acoustic transducer pig 206 by analyzing detected acoustic power over time. In a subsea pipeline, acoustic waves coupling with seawater can propagate for long distances and thus may be measured from a surface vessel or by floating or underwater vehicles rather than using emplaced acoustic sensors such as shown at 108 in FIG. 1.

In another embodiment, the acoustic wave (107 in FIG. 1) propagating from the acoustic transducer pig 206 may be modulated to transmit a real time information signal. By using techniques known to those skilled in the art, such as frequency shift keying (FSK) a sinusoid carrier wave may be modulated with the information intended for transmission. By decoding the detected acoustic waves (e.g., using the acoustic sensors 108) with the same technique, the transmitted data may be obtained remotely.

In another embodiment, a free-flooding ring transducer is used as the acoustic transducer 206.

In another embodiment, a piezoelectric stack transducer is used as the acoustic transducer 206.

In another embodiment, an electrodynamic transducer is used as the acoustic transducer 206. This type of transducer is described in U.S. Pat. No. 4,763,307, the content of which is incorporated by reference herein in its entirety and for all purposes

In another embodiment, the leak detection system comprises a fiber optic distributed acoustic leak detection system, wherein the acoustic sensors (108 in FIG. 1) may comprise or be in signal communication with optical fiber(s).

In another embodiments, the acoustic transmitter pig 106 may comprise other pipeline inspection devices such as magnetic flux leakage sensors, ultrasonic sensors and/or calipers.

In another embodiment the signals generated by the acoustic transmitter pig 106 and measured by acoustic sensor 108 is used to capture the location of the pig for post-processing of pig's measurement data. For example the time of maximum signal amplitude can be recorded to determine the location of the pig. This data can be used for correlation of the measurements made by the pig to pipeline locations.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A pipeline leak detection system, comprising:
a pig movable through a pipeline, the pig comprising an acoustic transducer;
a plurality of acoustic sensors disposed at spaced apart locations along the pipeline, each acoustic sensor in signal communication with a central processor; and
wherein the central processor accepts as input signals detected by each of the plurality of acoustic sensors and compares the detected signals to expected signals to determine performance degradation of the pipeline leak detection system and/or a leak in the pipeline.

2. The system of claim 1 wherein the acoustic transducer comprises a magnetostrictive transducer.

3. The system of claim 1 wherein the pig comprises circuitry to drive the acoustic transducer to generate acoustic waves having a predetermined waveform.

4. A method for evaluating performance of a pipeline leak detection system, comprising:
emitting acoustic energy into the pipeline at a plurality of locations along the pipeline;
detecting acoustic energy at spaced apart locations along the pipeline;
comparing characteristics of the detected acoustic energy with respect to expected characteristics of acoustic energy at the spaced apart locations; and
determining at least one of a performance degradation and presence of a pipeline leak using results from the comparing.

5. The method of claim 4 wherein the expected characteristics are determined by detecting the acoustic energy at the spaced apart locations on a pipeline having known leak and acoustic sensor performance characteristics.

6. The method of claim 4 wherein the determining comprises determining existence in the detected acoustic energy at one or more frequencies corresponding to existence of a leak in the pipeline.

7. The method of claim 4 wherein the determining comprises detecting changes in frequency content in the detected acoustic energy corresponding to changes in pipeline wall thickness as a result of damage to or corrosion of the pipeline.

8. The method of claim 4 wherein the determining comprises detecting changes in detected acoustic energy amplitude above a predetermined threshold at any one or more of the spaced apart locations.

9. The method of claim 8 wherein the changes in detected acoustic energy amplitude corresponds to one or more selected frequencies.
